(19) United States
(12) Patent Application Publication
(10) Pub. No.: US 2007/0121245 A1
(43) Pub. Date: May 31, 2007

(54) THIN FILM MAGNETIC HEAD HAVING RECORDING COIL AND METHOD OF FORMING RECORDING COIL

(75) Inventors: Kiyoshi Kobayashi, Niigata-ken (JP); Sumihito Morita, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/564,735

(22) Filed: Nov. 29, 2006

(30) Foreign Application Priority Data
Nov. 30, 2005 (JP) 2005-345729

(51) Int. Cl. G11B 5/127

(52) U.S. Cl. 360/125

(57) ABSTRACT

Disclosed are a thin film magnetic head that has a recoding coil and a method of forming a recording coil can sufficiently achieve a cross-sectional area of the coil and reduce coil resistance. A recording coil of a thin film magnetic head is formed as follows. First, frames, which divide a coil forming area, are formed on the plating base film for forming a coil. Further, the plating base film exposed between the frames is etched, and etching rebounds the plating base film are re-attached to a frame side wall. Then, a nonmagnetic metal layer is formed by plating on the area divided by the frames. Accordingly, the recording coil that has a thickness at both end portions in a coil width direction that is larger than that of a central portion thereof is obtained.

This application claims the benefit of Japanese Patent Application No. 2005-345729 filed Nov. 30, 2005, which is hereby incorporated by reference.

### BACKGROUND

1. Field

The present embodiments relate to a thin film magnetic head having a recording coil and a method of forming the recording coil.

2. Related Art

Generally, a recording element unit of a thin film magnetic head includes a core formed of a magnetic material. A recording coil generates a recording magnetic field in the core. A magnetic gap is formed at a front end of the core.

The thin film magnetic head records magnetic information on a recording medium by a leakage magnetic field that is generated from the core with the magnetic gap interposed therebetween at a surface that faces the recording medium. In this thin film magnetic head, the recording coil is generally formed by a frame-plating method. A frame, which divides a coil forming area, is formed on a plating base film by using, for example, photoresist, and the recording coil is formed in the frame by plating. The frame is removed. The plating base film remaining between pitches of the recording coil is removed by milling. In this way, the recording coil is formed (for example, see JP-A-2002-133611).

In the related art, as shown in FIG. 8A, in a cross section of the recording coil C right after the plating in a coil width direction, the recording coil C has a top surface that has a convex shape, and has a thickness d3 at both end portions thereof that is smaller than a thickness d4 at a central portion thereof (d3<d4). As described above, after the coil is formed, the milling process is performed to remove the plating base film. By this milling process, both end portions of the top surface of the recording coil C are cut.

As shown in FIG. 8B, the finally obtained recording coil C has both end portions C1 of the top surface thereof which are excessively cut. As a result, a cross-sectional area of the recording coil C is reduced below a design value, which causes an increase in electric resistance of the recording coil C. When the electric resistance of the recording coil C increases, the recording element unit is likely to be expanded by heat radiating from the recording coil C and protrude toward the recording medium. The protrusion may damage the recording medium, or the thin film magnetic head itself may be damaged.

### SUMMARY

The present embodiments may obviate one or more of the drawbacks inherent in the related art. For example, in one embodiment, a thin film magnetic head having a recording coil has a reduced coil resistance.

In one embodiment, a method ensures a cross-sectional area of a recording coil by forming both end portions of the recording coil to be thicker than the central portion thereof by plating, such that a top surface of the recording coil in a completed state is flat or has a concave shape. Both end portions of the top surface of the recording coil are likely to be cut by a milling process (i.e., a process of removing an unnecessary plating base film) that is performed after the coil is formed.

According to one embodiment, a thin film magnetic head includes a recording coil that applies a recording magnetic field to a core formed of a magnetic material. The recording coil has a thickness at both end portions thereof that is larger than that at a central portion thereof in a cross section in a coil width direction perpendicular to a coil extending direction.

In one embodiment, a top surface of the recording coil has a concave shape such that both end portions of the recording coil in the coil width direction are higher than the central portion thereof. The recording coil may be formed of a nonmagnetic metal plating film that is grown by plating on the metal base film.

In one embodiment, a method of forming a recording coil of a thin film magnetic head includes the recording coil that applies a recording magnetic field to a core formed of a magnetic material. The method includes forming a plating base film for forming a coil, forming frames, which divide a coil forming area, on the plating base film, etching the plating base film exposed between the frames, and re-attaching etching rebounds of the plating base film to a frame side wall, forming the recording coil by plating on the area divided by the frames, and removing the frames and the plating base film that is exposed between pitches of the recording coil.

In one embodiment, the plating base film that is not covered by the frame is etched by reactive ion etching or milling. The plating base film may be re-attached partially to a frame side wall, more specifically, from a lower side of the frame side wall. The plating base film may be attached to the frame side wall even though a pitch interval of the coil is smaller.

In one embodiment, since the recording coil has end portions in the coil width direction that are thicker than the central portion by plating, it is possible to sufficiently achieve a cross-sectional area of the coil in a complete state even though both end portions of the upper surface of the recording coil is cut in the milling process after the plating is formed. Accordingly, a thin film magnetic head that has a recording coil and a method of forming a recording coil that are capable of reducing coil resistance are obtained.

### BRIEF DESCRIPTION OF THE DRAWINGS

FIG. 1 is a partial longitudinal sectional view of one embodiment of a laminated structure of a thin film magnetic head;

FIG. 2 is a partially enlarged sectional view of one embodiment of a lower coil of FIG. 1;

FIG. 3 is a cross-sectional view of one embodiment of a process of forming the lower coil;

FIG. 4 is a cross-sectional view of one embodiment of a process of forming the lower coil;

FIG. 5 is a cross-sectional view of one embodiment of a process of forming the lower coil;

FIG. 6 is a cross-sectional view of one embodiment of a process of forming the lower coil;

FIG. 7 is a cross-sectional view of one embodiment of a process of forming the lower coil;

FIG. 8A is a cross-sectional view that illustrates a recording coil right after being formed by plating according to the related art; and

FIG. 8B is a view that illustrates a recording coil (complete state) that is formed by using a method according to the related art.

### DETAILED DESCRIPTION OF PREFERRED EMBODIMENTS

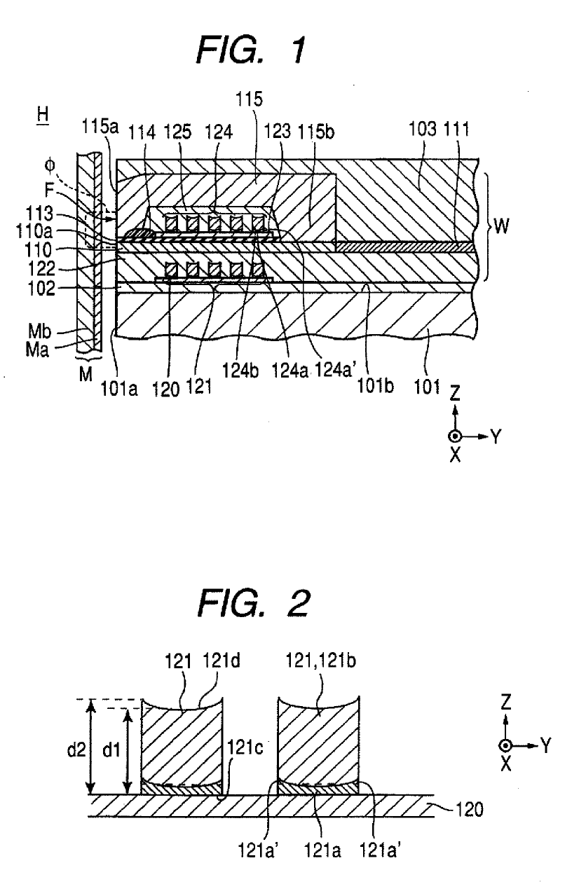

FIG. 1 is a partial longitudinal view that illustrates a laminated structure of a thin film magnetic head according to one embodiment. In FIG. 1, an X direction is defined as a track width direction, a Y direction is defined as a height direction, and a Z direction is defined as a lamination direction of respective layers that forms a thin film magnetic head.

The thin film magnetic head H is a perpendicular magnetic head that performs a recording operation by applying a perpendicular magnetic field φ to a recording medium M, and magnetizing a hard film Ma of the recording medium M in a perpendicular direction. The recording medium M includes the hard film Ma that has a high residual magnetization and located at the side of the surface of the recording medium, and a soft film Mb that has a high magnetic permeability and located closer to an inner side of the recording medium than the hard film Ma. The recording medium M has, for example, a disc shape, and rotates around the center of the disc that serves as a center of a rotary axis.

The thin film magnetic head H has, on an end surface 101b at a trailing side of a slider 101, a nonmagnetic insulating layer 102, a recording element unit W, and a surface protective layer 103 that covers the recording element unit W.

In one embodiment, the slider 101 is formed of a nonmagnetic material, for example, Al₂O₃.TiC. A medium-facing surface 101a of the slider 101 faces the recording medium M. When the recording medium M rotates, the slider 101 floats above the surface of the recording medium M because of an airflow generated along the surface of the recording medium M. The slider 101 may slide on the recording medium M. The nonmagnetic insulating layer 102 and the surface protective layer 103 are formed of an inorganic material, for example, Al₂O₃ or SiO₂.

The recording element unit W includes a main magnetic pole layer (a core) 110, an auxiliary magnetic pole layer 115, a magnetic gap layer 113 interposed between the main magnetic pole layer 110 and the auxiliary magnetic pole layer 115 at a surface F that faces the recording medium. A recording coil applies a recording magnetic field to the main magnetic pole layer 110 and the auxiliary magnetic pole layer 115.

The main magnetic pole layer 110 and the auxiliary magnetic pole layer 115 are formed of a ferromagnetic material, for example, Ni—Fe, Co—Fe, or Ni—Fe—Co, which has a high saturated magnetic flux density. The main magnetic pole layer 110 has a predetermined length extending from the facing surface F in the Y direction (the height direction) shown in the drawing, and the size of a front end surface 110a, which is exposed to the facing surface F, in the X direction (the track width direction) show in the drawing, is defined as the track width. An insulating material layer 111 formed of a material, for example, Al₂O₃, SiO₂, or Al—Si—O, is formed at both sides of the main magnetic pole layer 110 in the X direction and a rear side of the main magnetic pole layer 110 in the Y direction.

The magnetic gap layer 113 is formed of a nonmagnetic insulating material, for example, alumina or SiO₂. The magnetic gap layer 113 is formed on the main magnetic pole layer 110 and the insulating material layer 111. The auxiliary magnetic pole layer 115 faces the main magnetic pole layer 110 with a gap G interposed therebetween at a front end surface 115a that is exposed to the facing surface F.

The auxiliary magnetic pole layer 115 is coupled with the main magnetic pole layer 110 by a coupling portion 115b that is located closer to the inside in the height direction than the front end surface 115a. A height determining layer 114 formed of an inorganic or organic material is formed at the location of the magnetic gap layer 113 which is spaced from the facing surface F by a predetermined distance. On the basis of the distance from the facing surface F to a front end edge of the height determining layer 114, the throat height of the thin film magnetic head H is determined.

The recording coil includes a lower coil 121 that is formed on the nonmagnetic insulating layer 102 with a coil insulating base film 120 interposed therebetween. An upper coil 124 is formed on the magnetic gap layer 113 with a coil insulating base film 123 interposed therebetween. End portions of the lower coil 121 and the upper coil 124 are electrically connected to each other in the track width direction. The lower coil 121 and the upper coil 124 wind around the main magnetic pole layer 110 to thereby form a solenoid coil. Coil insulating layers 122 and 125 formed of an inorganic insulating material, for example, Al₂O₃, or an organic insulating material, for example, a resist, are formed around the lower coil 121 and the upper coil 124, respectively. Top surfaces of the coil insulating layers 122 and 125 are planarized, and the main magnetic pole layer 110 and the auxiliary magnetic pole layer 115 are formed on these flat surfaces, respectively.

The lower coil 121 includes plating base films 121a and 121a1′, which are formed of a nonmagnetic metal material, for example, Cu, Au, or the like. A metal plating layer 121b grown from the plating base films 121a and 121a′ by plating uses one nonmagnetic metal material or two or more nonmagnetic metal materials selected from a group comprising of, for example, Au, Cu, Al, or Ni.

Similar to the lower coil 121, the upper coil 124 includes plating base films 124a and 124a′, which are formed of a nonmagnetic metal material, for example, Cu, Au, or the like, and a metal plating layer 124b grown from the plating base films 124a and 124a′ by plating that uses one nonmagnetic metal material or two or more nonmagnetic metal materials selected from the group comprising of Au, Cu, Al, or Ni.

FIG. 2 is an enlarged sectional view that illustrates the lower coil 121. As shown in FIG. 2, the lower coil 121 has a thickness d2 at both end portions thereof that is larger than a thickness d1 at a central portion thereof (d2>d1) in a cross section (i.e., a cross section shown in FIG. 2) in a coil width direction (Y direction in FIG. 2) perpendicular to a coil extending direction (X direction in FIG. 2). For example, a bottom surface 121c of the lower coil 121 (i.e., a lower surface of the plating base film 121a) is a flat surface, and a top surface 121d of the lower coil 121 (i.e., a top surface of the metal plating layer 121b) has a concave shape where both end portions thereof in the coil width direction are higher than the central portion thereof.

In one embodiment, when both end portions in the coil width direction protrude further than the central portion, it is possible to achieve a large cross-sectional area of the coil and reduce coil resistance, as compared with when the both end portions in the coil width direction are flat or are depressed more than the central portion thereof (shown by dotted lines in FIG. 2).

The lower coil 121 has no problem in generating a recording magnetic field despite both of the protruding end portions in the coil width direction. The lower coil 121 and the upper coil 124 have the same shape. Even though the upper coil 124 is not described in detail, the upper coil 124 has both end portions that have a thickness larger than a central portion thereof in a cross section (a cross section shown in FIG. 2) in the coil width direction perpendicular to the coil extending direction (a longitudinal direction).

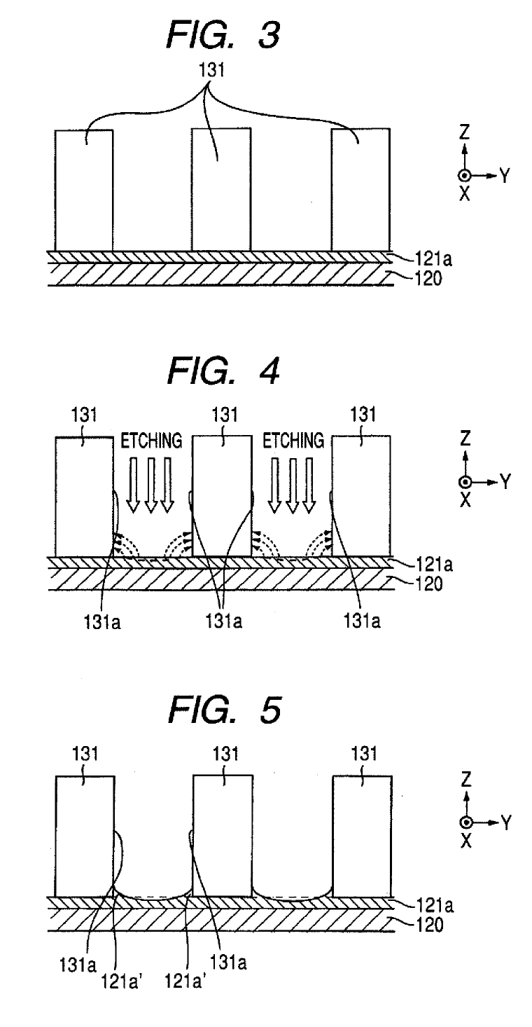

A method of forming a coil according to one embodiment will now be described with reference to FIGS. 3 to 7. FIGS. 3 to 7 illustrate processes of forming the lower coil 121. In one embodiment, since the lower coil 121 and the upper coil 124 are formed to have the same shape according to the same process order, the processes of forming the lower coil 121 will be described hereinafter.

First, as shown in FIG. 3, the plating base film 121a is formed on the coil insulating base film 120. The frames 131 that divide a coil-forming area are formed on the plating base film 121a. The plating base film 121a is formed of a nonmagnetic metal material, for example, Cu or Au, and the frame 131 is formed of resist.

As shown in FIG. 4, etching is performed as a process prior to plating. In the etching, the plating base film 121a exposed between the frames 131 is cut by about 30 to 300 Å by means of reactive ion etching (RIE) or milling that uses, for example, an Ar ion. When the plating base film 121a is etched, since the frame 131 is located most adjacent to both sides of the plating base film 121a, rebounds from the plating base film 121a are attached to a frame side wall 131a.

As shown in FIG. 5, a side plating base film 121a′ is formed at the frame side wall 131a. The rebounds of the plating base film 121a are likely to be sequentially attached to the frame side wall 131a from a lower side of the frame side wall 131a. As an amount of etching of the plating base film 121a increases, the side plating base film 121a1 is expanded toward an upper side of the frame side wall 131a. A range (area and height) in which the side plating base film 121a′ is formed can be controlled by the amount of etching of the plating base film 121a.

The lower coil 121 is formed by plating in the area divided by the frame 131. For example, the metal plating layer 121b, which is formed of one nonmagnetic metal material or two or more nonmagnetic metal materials selected from the group comprising of, for example, Au, Cu, Al, or Ni, is grown by plating on the plating base film 121a, which becomes a coil bottom layer, and the side plating base film 121a′ located at the side.

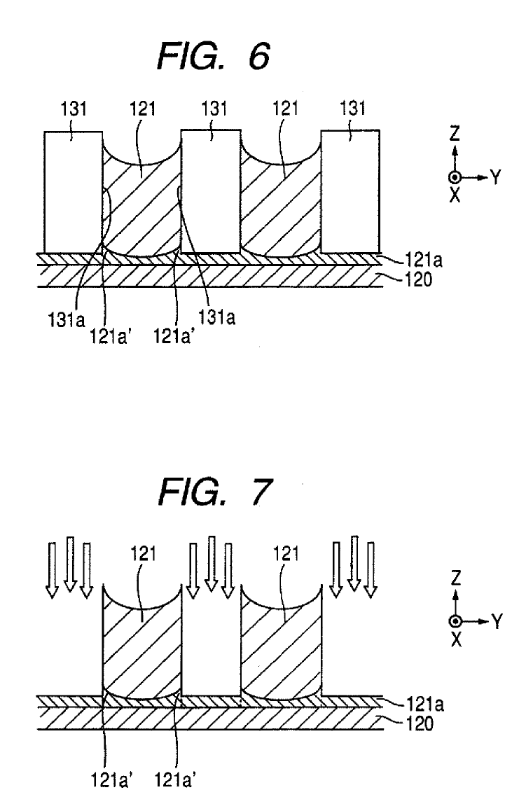

As shown in FIG. 6, as the lower coil 121 is formed by growing the metal plating layer 121b simultaneously from both the plating base film 121a and the side plating base films 121a′ by plating, the lower coil 121 has a thickness at both end portions in the coil width direction that is larger than that at a central portion thereof. In this embodiment, a bottom surface 121c of the lower coil 121 (a bottom surface of the plating base film 121a) is a flat surface, and a top surface 121d of the lower coil 121 (a top surface of the metal plating layer 121b) has a gentle concave shape where both end portions thereof are higher than the central portion thereof. A shape in section of the lower coil 121 is determined according to the amount of etching of the plating base film 121a that is performed in the previous process. For example, when the amount of etching of the plating base film 121a increases, the side plating base film 121a′ formed at the frame side wall 131a increases. A difference in thickness (d1−d2) between both end portions of the lower coil 121 in the coil width direction and the central portion thereof increases.

In contrast, when the amount of etching of the plating base film 121a decreases, the side plating base film 121a′ formed at the frame side wall 131a decreases. Therefore, the difference in thickness (d1−d2) between both end portions of the lower coil 121 in the coil width direction and the central portion thereof decreases.

After the lower coil 121 is formed, as shown in FIG. 7, the frame 131 is removed. The remaining plating base film 121a existing between pitches of the lower coils 121 is removed by milling. In this milling process, the lower coil 121 is cut at the same time as removing the plating base film 121a, and especially, both end portions of the lower coil 121 in the coil width direction are largely cut. However, as described above, since the lower coil 121 is formed such that the thickness d1 at both end portions in the coil width direction is greater than the thickness d2 at the central portion thereof, the sectional area of the lower coil 121 is sufficiently achieved even though the milling process is performed.

In one embodiment, the lower coil 121 is completed. The upper coil 124 can be formed by the same process as the process of forming the lower coil 121.

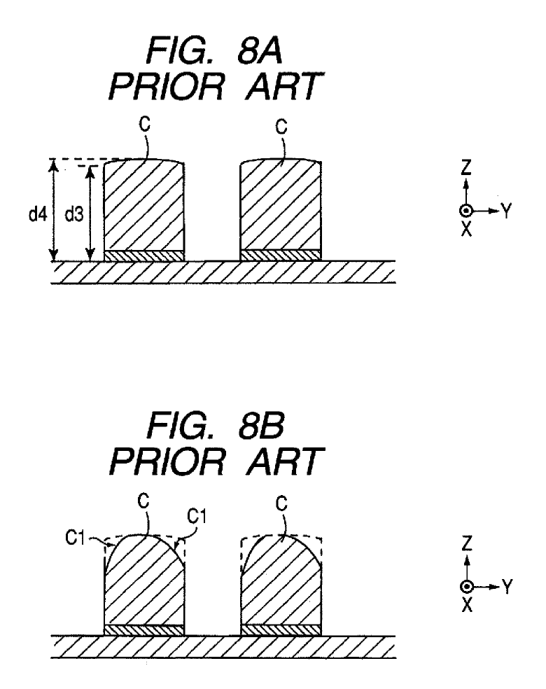

The lower coil 121 and the upper coil 124 that are formed in this embodiment can sufficiently achieve the sectional area in the coil width direction even though the milling process is performed after being formed by plating, because the thickness d2 at both end portions in the coil width direction is greater than the thickness d1 at the central portion. In this embodiment, it is possible to appropriately suppress the coil resistance, and the recording element unit W is not likely to be expanded to form a protrusion toward the recording medium. When the recording coil (the lower coil and the upper coil) C is plated to have a uniform thickness by using a method according to the related art, if the milling process of removing the plating base film is performed after being formed by plating, as shown in FIG. 8B, both end portions C1 of the recording coil C in the coil width direction are excessively cut. Therefore, it may be impossible to avoid an increase in the coil resistance due to a sharp reduction in the sectional area of the coil after the milling process.

In addition, in this embodiment, since a portion of the plating base film 121a is re-attached to the frame side wall 131a to thereby form the side plating base film 121a′ by etching (RIE or milling), even though a pitch interval of the coils formed is smaller, it is possible to re-attach the plating base film to the frame side wall 131a from the lower side of the frame side wall 131a.

A thin film magnetic head that includes a solenoid-shaped recording coil C that has the lower coil 121 and the upper coil 124 has been described. However, the present embodiments can be applied to a thin film magnetic head of a longitudinal recording type. The shape of the recording coil is not limited to a specific shape. For example, the recording coil may have a spiral shape in which the recording coil is wound around a coupling portion of the auxiliary magnetic pole layer in parallel to a surface of an auxiliary magnetic pole layer. The recording coil may be a single layer coil or a multilayer coil that has at least two layers.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A thin film magnetic head comprising:
a recording coil that applies a recording magnetic field to a core formed of a magnetic material,
wherein the recording coil has a thickness at both end portions thereof that is larger than a thickness at a central portion thereof in a cross section in a coil width direction perpendicular to a coil extending direction.

2. The thin film magnetic head according to claim 1,
wherein a top surface of the recording coil has a concave shape where both end portions of the recording coil in the coil width direction are higher than the central portion thereof.

3. The thin film magnetic head according to claim 1, wherein the recording coil is solenoid-shaped.

4. The thin film magnetic head according to claim 1, comprising a lower coil and an upper coil.

5. The thin film magnetic head according to claim 4, wherein the lower coil comprises the recording coil.

6. The thin film magnetic head according to claim 4, wherein the upper coil comprises the recording coil.

7. The thin film magnetic head according to claim 4, comprising a plurality of recording heads, wherein the lower coil comprises respective recording coils and the upper coil comprises respective recording coils.

8. The thin film magnetic head according to claim 1, comprising a thin film magnetic head of a longitudinal recording type.

9. The thin film magnetic head according to claim 1, comprising a thin film magnetic head of a perpendicular recording type.

10. The thin film magnetic head according to claim 1, wherein the recording coil comprises a spiral shape in which the recording coil is wound around a coupling portion of the auxiliary magnetic pole layer in parallel to a surface of an auxiliary magnetic pole layer.

11. The thin film magnetic head according to claim 1, wherein the recording coil may be a single layer coil or a multilayer coil that has at least two layers.

12. A method of forming a recording coil of a thin film magnetic head, the method comprising:
forming a plating base film for forming a coil;
forming frames, which divide a coil-forming area, on the plating base film;
etching the plating base film exposed between the frames, and re-attaching etching rebounds of the plating base film to a frame side wall;
forming the recording coil by plating on the area divided by the frames; and
removing the frames and the plating base film that is exposed between pitches of the recording coil.

13. The method of forming a recording coil of a thin film magnetic head according to claim 12,
wherein the plating base film that is not covered by the frames is etched by reactive ion etching or milling.
